(19) United States
(12) Patent Application Publication
(10) Pub. No.: US 2009/0164460 A1
(43) Pub. Date: Jun. 25, 2009

(54) Digital television video program providing system, digital television, and control method for the same

(75) Inventors: Yong Ju Jung, Daejeon (KR); Du-Sik Park, Suwon-si (KR); Aron Baik, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELCETRONICS CO., LTD., Suwon-si (KR)

(21) Appl. No.: 12/078,792

(22) Filed: Apr. 4, 2008

(30) Foreign Application Priority Data
Dec. 21, 2007 (KR) 10-2007-0135844

(51) Int. Cl. G06F 7/06; G06F 17/30

(52) U.S. Cl. 707/5; 707/3; 707/E17.017

(57) ABSTRACT

Disclosed are a digital television video program providing system, a digital television, and a control method for the same. The digital television video program providing system includes a video analyzing unit for extracting search terms from information data associated with a played video, a search keyword extracting unit for selecting a search keyword from the extracted search terms based on a reliability factor acquired by an extraction method of the extracted search terms, a video search unit for searching for a playable video based on the selected search keyword, and a search result providing unit for providing search results for the video.

### CROSS-REFERENCE TO RELATED APPLICATION

This application claims the benefit of Korean Patent Application No. 10-2007-0135844, filed on Dec. 21, 2007, in the Korean Intellectual Property Office, the entire disclosure of which is incorporated herein by reference.

### BACKGROUND OF THE INVENTION

1. Field of the Invention

The present invention relates to a digital television video program providing system, a digital television, and a control method for the same, and more particularly, to a digital television video program providing system, a digital television, and a control method for the same which can provide another video associated with a video being currently viewed.

2. Description of Related Art

Recently, an Internet Protocol (IP) television, a mobile IP television, and the like have been widely distributed, and accordingly, demands for a digital television and a video source which are connected with a network dramatically increase.

In this regard, a current digital television serves as an integrated entertainment means capable of realizing active participation of viewers and providing opinions of the viewers as well as simply being viewed. For this purpose, the television is required to satisfy an inherent function of image reproduction and also provide various information.

In particular, desires of viewers are to readily search for and watch various videos in addition to being unilaterally provided with videos by a broadcasting company. However, there is a problem in that viewers have to directly input text search terms in order to search for television video programs or images through the television.

### SUMMARY OF THE INVENTION

An aspect of the present invention provides a digital television video program providing system, a digital television, and a control method for the same, which can automatically analyze information associated with a video currently being viewed and generate a search keyword being reliable, to thereby search for and recommend a related video without inconvenience such as directly inputting search terms by a user.

According to an aspect of the present invention, there is provided a system for providing a digital television video program, which includes: a video analyzing unit for extracting search terms from information data associated with a played video; a search keyword extracting unit for selecting a search keyword from the extracted search terms based on a reliability factor acquired by an extraction method of the extracted search terms; a video search unit for searching for a playable video based on the selected search keyword; and a search result providing unit for providing search results for the video.

Also, the system for providing the digital television video program may further include a video ranking unit for ranking the search results for the video based on a priority produced from information associated with the video.

In this instance, the information data may correspond to any one of Closed Caption data, Meta Tag data, Electric Program Guide (EPG) data, audio data, visual data of the video, and text data of the video.

In this instance, the search keyword extracting unit may includes: a first search keyword extracting unit for selecting a temporary search keyword based on a reliability factor acquired by each method for extracting the search terms from the video; a search keyword suitability determining unit for determining whether the selected temporary search keyword is suitable for searching for the video; an additional information search unit for searching for and providing additional information for selecting the search keyword from an external database when the temporary search keyword is unsuitable for searching for the video according to the determination result; and a final search keyword extracting unit for extracting the search keyword using the temporary search keyword or the additional information provided by the additional information searching unit.

In this instance, the video ranking unit may include a viewing history analyzing unit for analyzing a record of the video viewed by a viewer; a priority producing unit for producing the priority using the analyzed results of the record and the information associated with the video; and a search result ranking unit for ranking the search results for the video based on the produced priority.

In this instance, the search result providing unit may provide the search results for the video in a Graphical User Interface (GUI).

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a configuration diagram illustrating a system for providing a digital television video program according to an exemplary embodiment of the present invention;

FIG. 2 is a configuration diagram illustrating a video analyzing unit of FIG. 1;

FIG. 3 is a configuration diagram illustrating a search keyword extracting unit of FIG. 1;

FIG. 4 is a configuration diagram illustrating a video ranking unit of FIG. 1;

FIG. 5 is a diagram illustrating a process for searching for and providing a video according to an exemplary embodiment of the present invention;

FIG. 6 is a diagram illustrating a process for searching for and providing a video according to another exemplary embodiment of the present invention;

FIG. 7 is a diagram illustrating a remote control of a digital television for providing a search of a video according to an exemplary embodiment of the present invention;

FIG. 8 is a diagram illustrating a process for searching for and providing a video according to an exemplary embodiment of the present invention;

FIG. 9 is a diagram illustrating a process for searching for and providing a video according to another exemplary embodiment of the present invention;

FIG. 10 is a flowchart illustrating a method of controlling a digital television video program providing system according to an exemplary embodiment of the present invention; and

FIG. 11 is a flowchart illustrating a method of controlling a digital television according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

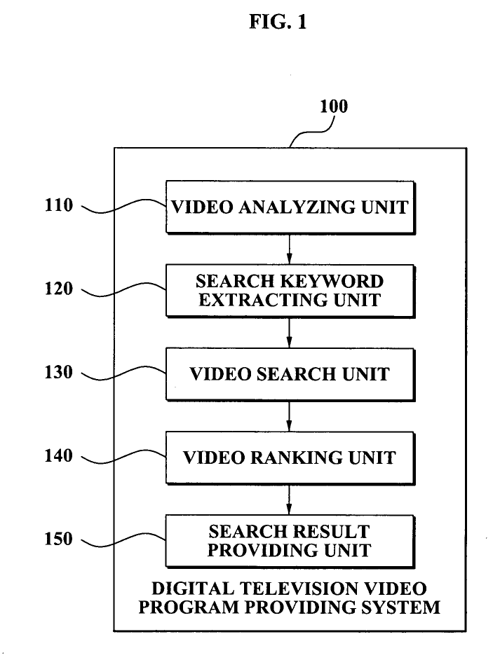

FIG. 1 is a configuration diagram illustrating a system 100 for providing a digital television video program according to an exemplary embodiment of the present invention.

Referring to FIG. 1, the system 100 for providing the digital television video program according to the present exemplary embodiment includes a video analyzing unit 110, a search keyword extracting unit 120, a video search unit 130, a video ranking unit 140, and a search result providing unit 150.

The video analyzing unit 110 extracts search terms from information data associated with a played video. In this instance, the information data of the played video used for extracting the search terms corresponds to Closed Caption data, Meta Tag data, Electric Program Guide (EPG) data, audio data, visual data of the video, text data of the video, and the like.

The video analyzing unit 110 extracts semantic information from the video, and uses the extracted semantic information as the search terms.

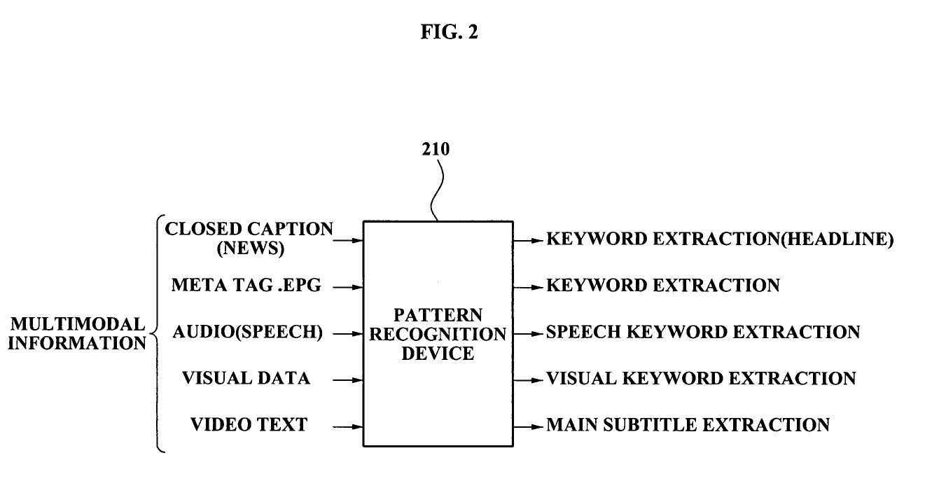

The search keyword extracting unit 120 selects a search keyword from the extracted search terms based on a reliability factor acquired by an extraction method of the extracted search terms. The reliability factor will be described in detail with reference to FIG. 2.

The video search unit 130 searches for a playable video based on the selected search keyword.

The search result providing unit 150 provides search results for the video. In this instance, the search results for the video may be provided in a Graphical User Interface (GUI).

The video ranking unit 140 ranks the search results for the video based on a priority produced from information associated with the video.

FIG. 2 is a configuration diagram illustrating the video analyzing unit 110 of FIG. 1. Referring to FIG. 2, the video analyzing unit 110 according to the present exemplary will be described in detail.

The video analyzing unit 110 extracts search terms from information data associated with a played video. In particular, the video analyzing unit 110 includes a pattern recognition device 210 and thus may extract the search terms from various kinds of information.

Specifically, the video analyzing unit 110 may extract the search terms from the Closed Caption data, Meta Tag data, EPG data, audio data, visual data of the video, text data of the video, and the like by using the pattern recognition device 210.

The video analyzing unit 110 may utilize a machine learning scheme and an inference scheme using the pattern recognition device 210. For example, the video analyzing unit 110 recognizes visual information of the video to detect a visual concept, thereby extracting a result value composed of a keyword or a corresponding reliability factor of the keyword. Here, the reliability factor denotes a probability factor between ‘0’ and ‘1’, and is used as a measure for estimating an analyzing accuracy for the extracted keyword. For example, the extracted results may be expressed such as ‘Premier League, 1.0’, ‘Park, Ji Sung, 0.7’, ‘goal, 0.5’. Here, the ‘Premier League, 1.0’ indicates that the video includes semantic information of the Premier League having a reliability factor of ‘1.0’.

In analyzing content information of the video, for example, information with respect to goals or names of athletes, actors, and headlines which are extracted from a sport event, a movie or drama, and news contents, respectively, may be high-level semantic information.

For analyzing and extracting the semantic information, a speech recognition scheme using inputted audio information or a text analyzing scheme using Closed Caption information received by a news program channel may be used. Also, a text included in the EPG or Tag data is analyzed to thereby extract a keyword.

In the case of the visual information of the video, a main subtitle is extracted by detecting and recognizing subtitles such as ‘Video Text’ included in a video frame, or information about actors or a visual concept is extracted by using a face recognition function, thereby analyzing the content information. Here, the visual concept is determined in advance and denotes a semantic concept word. For example, in the case of a video including a scene such as ‘surfing in the beach’, visual data of the video may be analyzed to thereby extract a concept of ‘beach’.

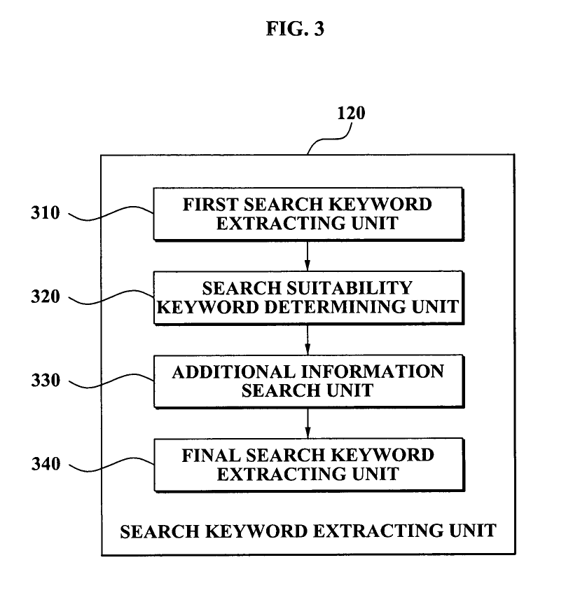

FIG. 3 is a configuration diagram illustrating the search keyword extracting unit 120 of FIG. 1. The search keyword extracting unit 120 according to the present exemplary embodiment will be described in detail with reference to FIG. 3.

As illustrated in FIG. 3, the search keyword extracting unit 120 according to the present exemplary embodiment includes a first search keyword extracting unit 310, a search keyword suitability determining unit 320, an additional information search unit 330, and a final search keyword extracting unit 340.

The first search keyword extracting unit 310 selects a temporary search keyword based on a reliability factor acquired by each method for extracting the search terms from the video.

The search keyword suitability determining unit 320 determines whether the selected temporary search keyword is suitable for searching for the video.

The additional information search unit 330 searches for and provides additional information for selecting the search keyword from an external database when the temporary search keyword is unsuitable for searching for the video according to the determination result.

The final search keyword extracting unit 340 extracts the search keyword using the temporary search keyword or the additional information provided by the additional information searching unit.

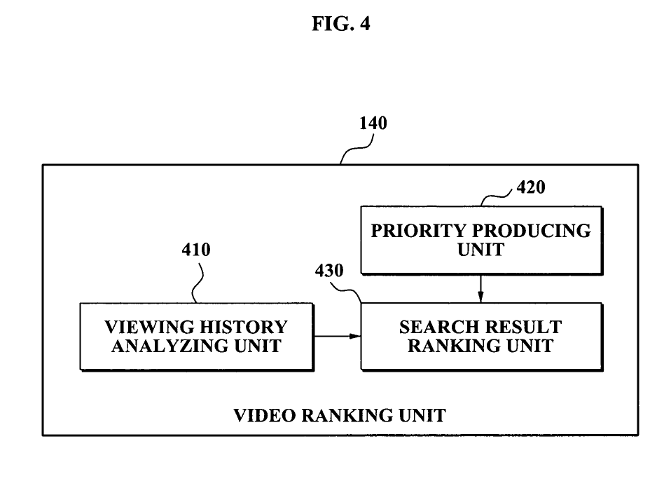

FIG. 4 is a configuration diagram illustrating the video ranking unit 140 of FIG. 1. The video ranking unit 140 according to the present exemplary embodiment will be described in detail with reference to FIG. 4.

As illustrated in FIG. 4, the video ranking unit 140 includes a viewing history analyzing unit 410, a priority producing unit 420, and a search result ranking unit 430.

The viewing history analyzing unit 410 analyzes a record of videos viewed by a viewer.

The priority producing unit 420 produces the priority using the analyzed results of the record and the information associated with the video.

The search result ranking unit 430 ranks the search results for the video based on the produced priority.

As illustrated in FIGS. 1, 2, 3, and 4, the system 100 for providing the digital television video program according to the present exemplary may be included in a digital television, and the digital television may include at least one of a video analyzing unit 110, a search keyword extracting unit 120, a video search requesting unit 130, a video ranking unit 140, and a search result utilization unit 150.

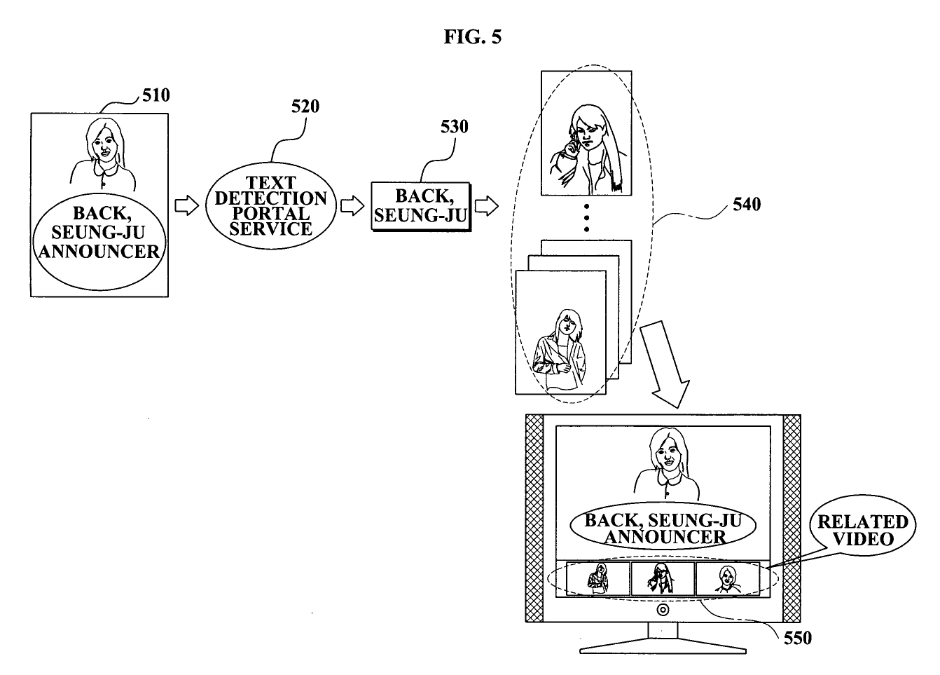

FIG. 5 is a diagram illustrating a process for searching for and providing a video 510 according to an exemplary embodiment of the present invention. The process for searching for and providing the video 510 according to the present exemplary embodiment will be described in detail with reference to FIG. 5.

A user selects a service for searching for the related video using a remote control while viewing the video 510, and analyzes the viewed video using a text detection portal service 520, to thereby extract a search keyword 530.

Next, using the extracted search keyword, a search of the related video is performed in a personal storage device such as a search engine capable of searching for Internet videos, a hard disk drive (HDD) of a set-top box, and a database of a Program Provider (PP) providing a video program.

The searched related videos are ranked 540 according to the viewing history or preference of the user, and the ranked videos are provided 550. In this instance, the provided videos may be selected and viewed.

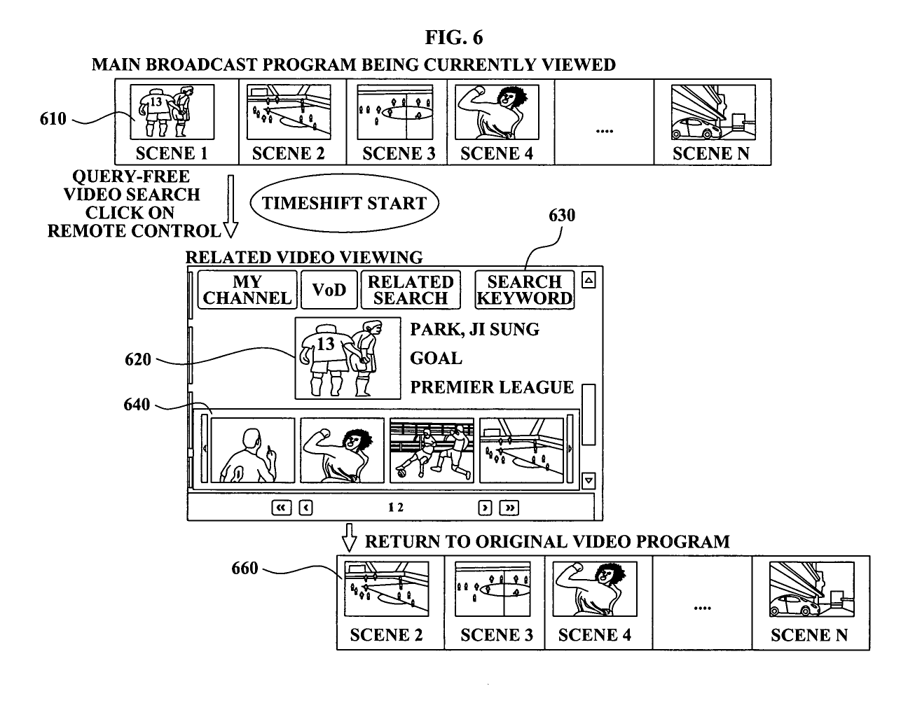

FIG. 6 is a diagram illustrating a process for searching for and providing a video 610 according to another exemplary embodiment of the present invention. The process for searching for and providing the video 610 according to the present exemplary embodiment will be described in detail with reference to FIG. 6.

As illustrated in FIG. 6, when a user selects a service for searching for the related video using a remote control while viewing the video 610, the viewed video 610 is recorded in a storage device for the purpose of time shifting, and analyzed to thereby extract a search keyword 630. [if these references are not correct, reference number 620 is not described in detailed description so need to delete from FIG. 6 or describe here] Next, related videos 640 associated with the viewed video 620 are acquired using the extracted search keyword 630, and the related videos 640 are realized in the GUI. The user may play and watch a desired video from among the related videos by selecting the desired video.

Next, when a reproduction of the desired video is finished, a screen is returned to a video 660 originally viewed, so that the user can continue to view the video 660.

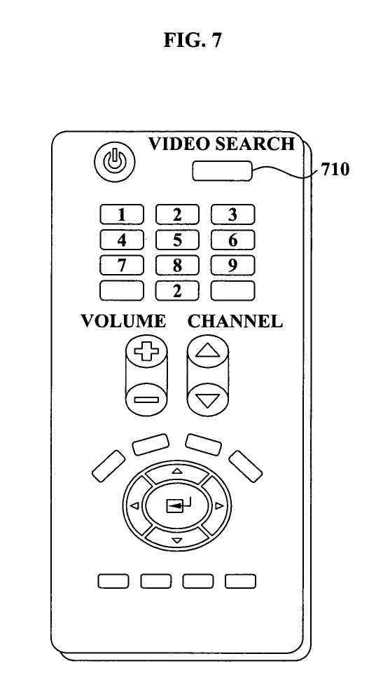

FIG. 7 is a diagram illustrating a remote control of a digital television for providing a search of a video according to an exemplary embodiment of the present invention. As illustrated in FIG. 7, the remote control of the digital television according to the present exemplary embodiment includes a separate short-cut button 710 for receiving related videos.

When the short-cut button 710 is pressed, a video being currently viewed is recorded for time shifting, and related videos associated with the currently viewed video are displayed on a screen of the digital television. As a result, a user can select and view a desired video from among the related videos using buttons such as numerical buttons, channel buttons, navigation buttons, and the like of the remote control.

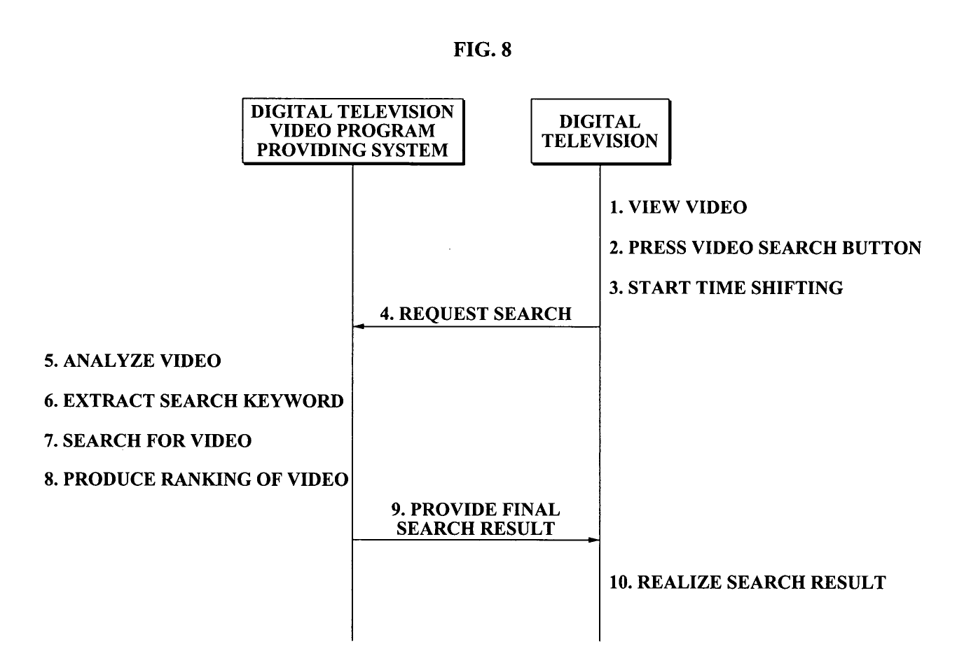

FIG. 8 is a diagram illustrating a process for searching for and providing a video according to an exemplary embodiment of the present invention. The process for searching for and providing the video according to the present exemplary embodiment will be described in detail with reference to FIG. 8.

When a user presses a video search button of a remote control of the digital television in order to search for a related video associated with a video being currently viewed while viewing the video via the digital television, the digital television starts time shifting, and the system for providing the digital television video program receives a request for a search of the related video.

The system for providing the digital television video program analyzes the video to extract a search keyword, and searches for a related video using the extracted search keyword. Next, the system produces a ranking of the searched videos, and provides final search results acquired according to the produced ranking to the digital television. Accordingly, the digital television realizes the search results in the GUI.

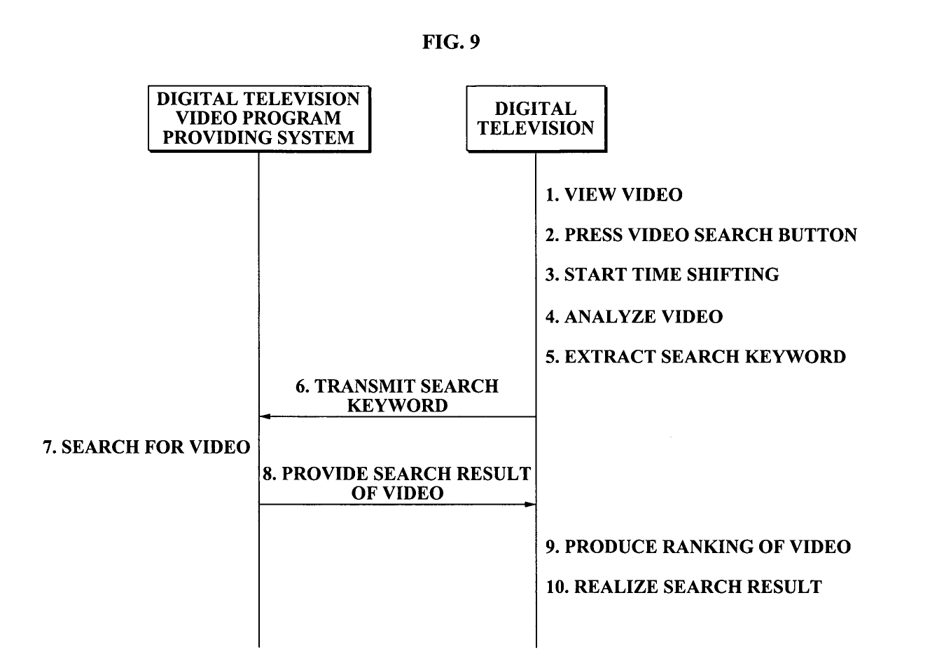

FIG. 9 is a diagram illustrating a process for searching for and providing a video according to another exemplary embodiment of the present invention. The process for searching for and providing the video according to the present exemplary embodiment will be described in detail with reference to FIG. 9.

When a user presses a video search button of a remote control of the digital television in order to search for a related video associated with the video being currently viewed while viewing the video via the digital television, the digital television starts time shifting, and analyzes the video.

The digital television extracts a search keyword through analyzing of the video, and transmits the extracted search keyword to the system for providing the digital television video program. The system searches for the related videos, and provides the search results of the related videos to the digital television.

The digital television produces a ranking of the related video using the search results of the related videos, and realizes the search results in the GUI.

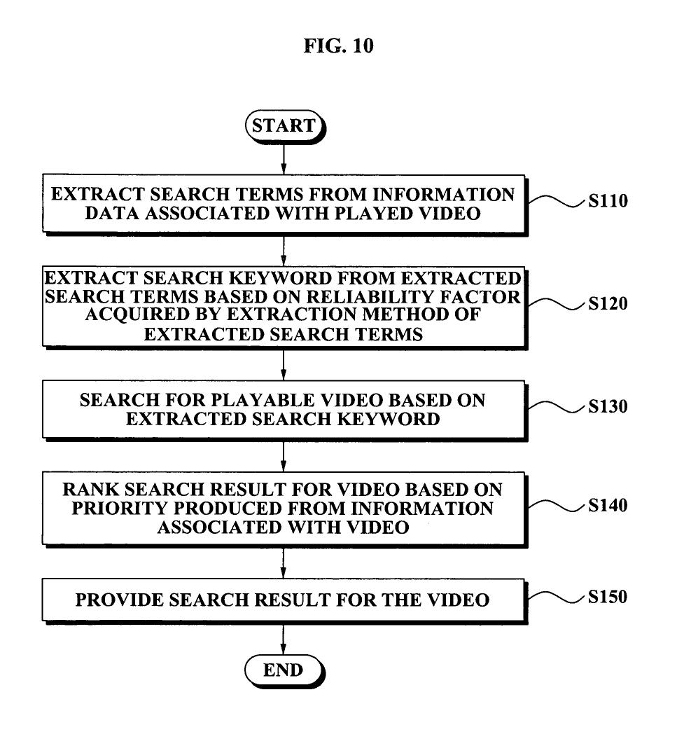

FIG. 10 is a flowchart illustrating a method of controlling a digital television video program providing system according to an exemplary embodiment of the present invention. The method of controlling the digital television video program providing system according to the present exemplary embodiment will be described in detail with reference to FIG. 10.

In operation S110, the method extracts search terms from information data associated with a played video. In this instance, Closed Caption data, Meta Tag data, EPG data, audio data, visual data of the video, text data of the video, and the like may be used for extracting the search terms from the information data.

In operation S120, the method extracts a search keyword from the extracted search terms based on a reliability factor acquired by an extraction method of the extracted search terms.

In this instance, for extracting the search keyword, a temporary search keyword may be selected based on a reliability factor acquired by each method for extracting the search terms from the video, whether the selected temporary search keyword is suitable for searching for the video may be determined, and additional information for selecting the search keyword from an external database may be searched for and provided when the temporary search keyword is unsuitable for searching for the video according to the determination result. Then the search keyword is provided using the temporary search keyword or the additional information provided by the additional information searching unit.

Next, in operation S130, the method searches for a playable video based on the extracted search keyword.

In operation S140, the method ranks search results for the video based on a priority produced from information associated with the video.

In this instance, for ranking the search results for the video, a record of videos viewed by a viewer may be analyzed, the priority may be produced using the analyzed results of the record and the information associated with the video, and the search results for the video may be ranked based on the produced priority.

Next, in operation S150, the method provides the search results for the video to the user. In this instance, the search results for the video may be provided in the GUI.

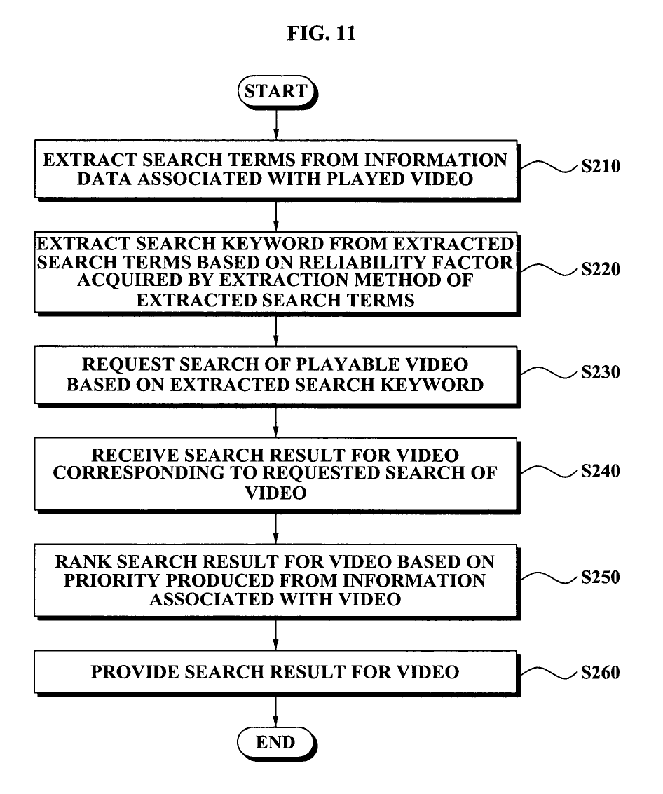

FIG. 11 is a flowchart illustrating a method of controlling a digital television according to an exemplary embodiment of the present invention. The method of controlling the digital television according to the present exemplary embodiment will be described in detail with reference to FIG. 11.

In operation S210, the method according to the present exemplary embodiment extracts search terms from information data associated with a played video. In this instance, Closed Caption data, Meta Tag data, EPG data, audio data, visual data of the video, text data of the video, and the like may be used for extracting the search terms from the information data.

In operation S220, the method extracts a search keyword from the extracted search terms based on a reliability factor acquired by an extraction method of the extracted search terms.

In this instance, for extracting the search keyword, a temporary search keyword may be selected based on a reliability factor acquired by each method for extracting the search terms from the video, whether the extracted temporary search keyword is suitable for searching for the video may be determined, and additional information for selecting the search keyword from an external database may be searched for and provided when the temporary search keyword is unsuitable for searching for the video according to the determination result. Then the search keyword may be extracted using the temporary search keyword or the additional information provided by the additional information searching unit.

Next, in operation S230, the method requests a search of a playable video based on the extracted search keyword.

In operation S240, the method receives search results for the video corresponding to the requested search of the video, and in operation S250, the method ranks the search results for the video based on a priority produced from information associated with the video.

In this instance, for ranking the search results for the video, a record of videos viewed by a viewer may be analyzed, the priority may be produced using the analyzed results of the record and the information associated with the video, and the search results for the video may be ranked based on the produced priority.

In operation S260, the method provides search results for the video. In this instance, the search results for the video may be provided in the GUI.

The method for controlling the digital television video program providing system according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for providing a digital television video program, the system comprising:
a video analyzing unit for extracting search terms from information data associated with a played video;
a search keyword extracting unit for selecting a search keyword from the extracted search terms based on a reliability factor acquired by an extraction method of the extracted search terms;
a video search unit for searching for a playable video based on the selected search keyword; and
a search result providing unit for providing search results for the video.

2. The system of claim 1, further comprising:
a video ranking unit for ranking the search results for the video based on a priority produced from information associated with the video.

3. The system of claim 1, wherein the information data corresponds to any one of Closed Caption data, Meta Tag data, Electric Program Guide (EPG) data, audio data, visual data of the video, and text data of the video.

4. The system of claim 1, wherein the search keyword extracting unit comprises:
a first search keyword extracting unit for selecting a temporary search keyword based on a reliability factor acquired by each method for extracting the search terms from the video;
a search keyword suitability determining unit for determining whether the selected temporary search keyword is suitable for searching for the video;
an additional information search unit for searching for and providing additional information for selecting the search keyword from an external database when the temporary search keyword is unsuitable for searching for the video according to the determination result; and
a final search keyword extracting unit for extracting the search keyword using the temporary search keyword or the additional information provided by the additional information searching unit.

5. The system of claim 2, wherein the video ranking unit comprises:
a viewing history analyzing unit for analyzing a record of the video viewed by a viewer;
a priority producing unit for producing the priority using the analyzed results of the record and the information associated with the video; and
a search result ranking unit for ranking the search results for the video based on the produced priority.

6. The system of claim 1, wherein the search result providing unit provides the search results for the video in a Graphical User Interface (GUI).

7. A digital television comprising:
a video analyzing unit for extracting search terms from information data associated with a played video;
a search keyword extracting unit for extracting a search keyword from the extracted search terms based on a reliability factor acquired by an extraction method of the extracted search terms;
a video search requesting unit for requesting a search of a playable video based on the selected search keyword; and
a search result utilization unit for utilizing search results of the video corresponding to the requested search of the video.

8. The digital television of claim 7, further comprising:
a video ranking unit for ranking the searching results for the video based on a priority produced from information associated with the video.

9. The digital television of claim 7, wherein the information data corresponds to any one of Closed Caption data, Meta Tag data, Electric Program Guide (EPG) data, audio data, visual data of the video, and text data of the video.

10. The digital television of claim 7, wherein the search keyword extracting unit comprises:
a first search keyword extracting unit for selecting a temporary search keyword based on a reliability factor acquired by each method for extracting the search terms from the video;
a search keyword suitability determining unit for determining whether the selected temporary search keyword is suitable for searching for the video;
an additional information searching unit for searching for and providing additional information for selecting the search keyword from an external database when the temporary search keyword is unsuitable for searching for the video according to the determination result; and
a final search keyword extracting unit for extracting the search keyword using the temporary search keyword or the additional information provided by the additional information searching unit.

11. The digital television of claim 8, wherein the video ranking unit comprises:
a viewing history analyzing unit for analyzing a record of videos viewed by a viewer;
a priority producing unit for producing the priority using the analyzed results of the record and the information associated with the video; and
a search result ranking unit for ranking the search results for the video based on the produced priority.

12. The digital television of claim 7, wherein the search result utilization unit utilizing the searching results for the video in a GUI.

13. A method for controlling a digital television video program providing system, the method comprising:
extracting search terms from information data associated with a played video;
extracting a search keyword from the extracted search terms based on a reliability factor acquired by an extraction method of the extracted search terms;
searching for a playable video based on the extracted search keyword; and
providing search results for the video.

14. The method of claim 13, further comprising:
ranking the search results for the video based on a priority produced from information associated with the video.

15. The method of claim 13, wherein the information data corresponds to any one of Closed Caption data, Meta Tag data, Electric Program Guide (EPG) data, audio data, visual data of the video, and text data of the video.

16. The method of claim 13, wherein the extracting of the search keyword comprises:
selecting a temporary search keyword based on a reliability factor acquired by each method for extracting the search terms from the video;
determining whether the selected temporary search keyword is suitable for searching for the video;
searching and providing additional information used for selecting the search keyword from an external database when the temporary search keyword is unsuitable for searching for the video according to the determination result; and
extracting the search keyword using the temporary search keyword or the additional information provided by the additional information searching unit.

17. The method of claim 14, wherein the ranking comprises:
analyzing a record of videos viewed by a viewer;
producing the priority using the analyzed results of the record and the information associated with the video; and
ranking the search results for the video based on the produced priority.

18. The method of claim 13, wherein providing of the search results for the video provides the search results for the video in a GUI.

19. A method of controlling a digital television, the method comprising:
extracting search terms from information data associated with a played video;
selecting a search keyword from the extracted search terms based on a reliability factor acquired by an extraction method of the extracted search terms;
requesting a search of a playable video based on the selected search keyword; and
utilizing search results for the video corresponding to the requested search of the video.

20. The method of claim 19, further comprising:
ranking the search results for the video based on priority produced from information associated with the video.

21. The method of claim 19, wherein the information data corresponds to any one of Closed Caption data, Meta Tag data, Electric Program Guide (EPG) data, audio data, visual data of the video, and text data of the video.

22. The method of claim 19, wherein the extracting of the search keyword comprises:
selecting a temporary search keyword based on a reliability factor acquired by each method for extracting search terms from the video;
determining whether the selected temporary search keyword is suitable for searching for the video;
searching and providing additional information used for selecting the search keyword from an external database when the temporary search keyword is unsuitable for searching for the video according to the determination result; and
extracting the search keyword using the temporary search keyword or the additional information provided by the additional information searching unit.

23. The method of claim 20, wherein the ranking of the search results for the video comprises:
analyzing a record of videos viewed by a viewer;
producing the priority using the analyzed results of the record and the information associated with the video; and
ranking the search results for the video based on the produced priority.

24. The method of claim 19, wherein the utilizing utilizes the search results for the video via a GUI.

25. A computer-readable recording medium storing a program for implementing the method of claim 13.
